(19) United States
(12) Patent Application Publication
(10) Pub. No.: US 2023/0311340 A1
(43) Pub. Date: Oct. 5, 2023

(54) ROLLING GRASP END EFFECTOR

(71) Applicants: Pratik Chawla, Foster City, CA (US); Sri Rama Prasanna Pavani, San Carlos, CA (US)

(72) Inventors: Pratik Chawla, Foster City, CA (US); Sri Rama Prasanna Pavani, San Carlos, CA (US)

(21) Appl. No.: 17/713,838

(22) Filed: Apr. 5, 2022

(51) Int. Cl. B25J 15/00

(52) U.S. Cl. CPC B25J 15/0028

(57) ABSTRACT

The invention is a system for handling an article, comprising: a first finger having a belt to make contact with said article; a first actuator configured to move said belt; a second finger surrounding said article; a second actuator to vary the distance between said first finger and said second finger; a processor executing an algorithm to control said first actuator to move said article, and to control said second actuator to hold said article; whereby said article is grasped by moving it to a position between said first finger and said second finger. The invention is also a method for handling an article, comprising: opening a first finger and a second finger such that they are not in contact with each other, wherein said first finger comprises a belt configured to move said article; positioning and orienting said first finger and said second finger such that said article is in between the tip of said fingers; closing said first finger and said second finger such that the tip of said fingers are in contact with said article; moving said belt to pull said article from the tip of said fingers to a position deeper inside said fingers, whereby said article is grasped by moving it to a position between said first finger and said second finger.

### FIELD OF THE INVENTION

This invention relates generally to handling a dish with an end effector attached to a robotic arm.

### BACKGROUND

Picking up, holding and dropping off dishes of different shapes and sizes may appear as routine unremarkable tasks for people. In reality, handling dishes is a complex activity that is uniquely made possible by the remarkable dexterity of human hands.

Our hands can adapt in form based on the dish they need to handle. For instance, the shape of our hand when it is holding a dinner plate is different from the shape of our hand when it is holding a coffee mug. Our hands can also adapt in function based on the actions we desire to perform. For instance, the sequence of actions our hand performs while picking up a spoon is distinct from the sequence of actions it performs while dropping off a bowl. Furthermore, our hands can make corrections for potential failures. For instance, when a glass cup is about to slip away, our hands sense imminent danger and perform one or more actions to get back to a stable grip.

Handling dishes is also complicated by the fact that we prefer to stack dishes on each other to maximize space efficiency. But stacking is not a big deal for our hands to handle, as their dexterity allows them to easily separate a dish from a bunch of its collocated clones. Furthermore, our preference for storing dishes inside cabinets of modular kitchens adds an additional layer of complexity as dishes are not readily accessible. This again is not an obstacle for our hands as they can pull and push cabinets with ease.

Conventional robots, however, are no match for human hands due to the limited dexterity of their end effectors. For instance, mechanical grippers and vacuum suction cups are unable to adapt to the needs for handling a variety of dish types. The differences between a spoon and a dinner plate are too overwhelming for these conventional end effectors to deal with. Such conventional end effectors are best suited for moving an independent object of a single type in an otherwise open unobstructed environment.

Accordingly, there is a need for an improved system and method to pick up, handle and drop off a dish. One that could pick up, hold, and drop off a variety of dish types; one that could pick up, hold, and drop off a stacked dish; one that could pick up, hold, and drop off a dish deep inside one of many cabinets which may be vertically or horizontally arranged, or otherwise in close proximity.

### SUMMARY

The invention is a system and method for handling a dish with an end effector attached to a robotic arm.

In some embodiments, the invention is a system for handling an article, comprising: a first finger having a belt to make contact with said article; a first actuator configured to move said belt; a second finger surrounding said article; a second actuator to vary the distance between said first finger and said second finger; a processor executing an algorithm to control said first actuator to move said article, and to control said second actuator to hold said article; whereby said article is grasped by moving it to a position between said first finger and said second finger.

A method for handling an article, comprising: opening a first finger and a second finger such that they are not in contact with each other, wherein said first finger comprises a belt configured to move said article; positioning and orienting said first finger and said second finger such that said article is in between the tip of said fingers; closing said first finger and said second finger such that the tip of said fingers are in contact with said article; moving said belt to pull said article from the tip of said fingers to a position deeper inside said fingers, whereby said article is grasped by moving it to a position between said first finger and said second finger.

### BRIEF DESCRIPTION OF THE DRAWINGS

FIG. 1 shows a three-dimensional view of a rolling grasp end effector with fingers open to display its maximum stroke length, in accordance with the invention.

FIG. 2 shows a three-dimensional view of a rolling grasp end effector with fingers open, showing different parts of the end effector, in accordance with the invention.

FIG. 3 shows a three-dimensional view of a rolling grasp end effector with fingers open, showing different parts of the fingers, in accordance with the invention.

FIG. 4 shows a three-dimensional view of a rolling grasp end effector with fingers closed to display its minimum stroke length, in accordance with the invention.

FIG. 5 shows a three-dimensional view of a rolling grasp end effector grasping a plate, in accordance with the invention.

FIG. 6 shows a right-side view of a rolling grasp end effector grasping a plate, in accordance with the invention.

FIG. 7 shows a left-side view of a rolling grasp end effector grasping a plate, in accordance with the invention.

FIG. 8 shows a top view of a rolling grasp end effector grasping a plate, in accordance with the invention.

FIG. 9 shows a bottom view of a rolling grasp end effector grasping a plate, in accordance with the invention.

FIG. 10 shows a front view of a rolling grasp end effector grasping a plate, in accordance with the invention.

FIG. 11 shows a three-dimensional view of a rolling grasp end effector grasping a bowl, in accordance with the invention.

FIG. 12 shows a three-dimensional view of a rolling grasp end effector grasping a chopstick, in accordance with the invention.

FIG. 13 shows a three-dimensional view of a rolling grasp end effector grasping a fork, in accordance with the invention.

FIG. 14 shows a three-dimensional view of a rolling grasp end effector grasping a mug, in accordance with the invention.

FIG. 15 shows a right-side view of a rolling grasp end effector, in accordance with the invention.

FIG. 16 shows a left-side view of a rolling grasp end effector, in accordance with the invention.

FIG. 17 shows a back view of a rolling grasp end effector, in accordance with the invention.

FIG. 18 shows a top view of a rolling grasp end effector, in accordance with the invention.

FIG. 19 shows a bottom view of a rolling grasp end effector, in accordance with the invention.

FIG. 20 shows a method for grasping a dish with a rolling grasp end effector, in accordance with the invention.

FIG. 21 shows the fingers of the end-effector opened such that they do not make contact with each other, in accordance with the invention.

FIG. 22 shows the fingers positioned and oriented such that a dish is between the tip of the fingers, in accordance with the invention.

FIG. 23 shows the fingers closed to make the tip of the fingers to contact the dish, in accordance with the invention.

FIG. 24 shows the belt in a finger moving to pull the dish from the tip of the fingers to a position deeper inside the fingers, in accordance with the invention.

### DETAILED DESCRIPTION OF THE PREFERRED EMBODIMENTS

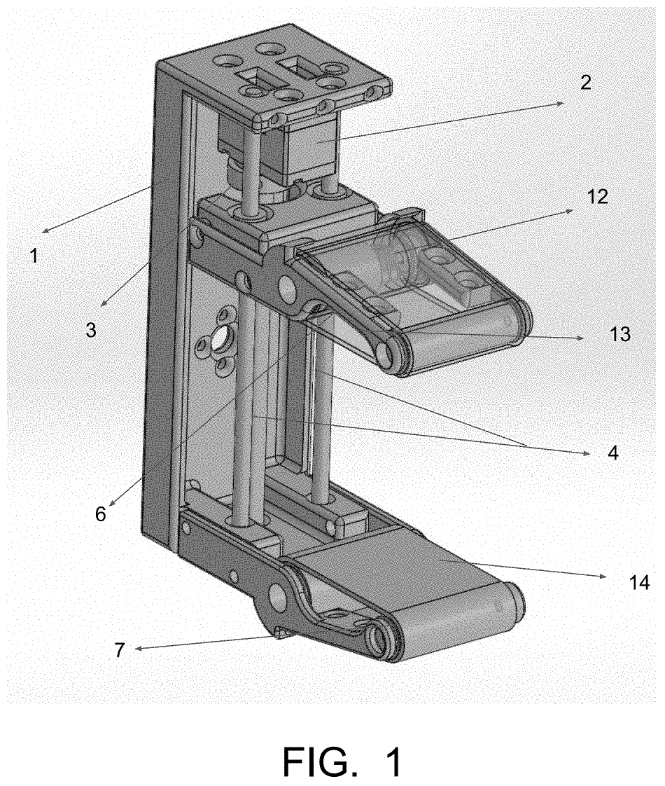

FIG. 1 shows a three-dimensional view of a rolling grasp end effector with fingers 6 and 7 separated, in accordance with the invention. In some embodiments, the end effector has two fingers 6 and 7. In some embodiments, one finger 7 is stationary and the other finger 6 can translate to configure its distance from finger 7. In other embodiments, finger 6 is placed on top of the finger 7. In some embodiments, fingers 6 and 7 are substantially parallel to each other. In some embodiments, guide rods 4 aid in supporting finger 6 during translation. In some embodiments, links 8 and 9 aid in supporting the structure of finger 6, and links 10 and 11 aid in supporting the structure of finger 7.

In some embodiments, fingers 6 and 7 of the end effector has rollers 12, 13 to grasp and manipulate dishes. In some embodiments, a roller is driven by a motor. In other embodiments, a roller is not actively driven by a motor. In some embodiments, fingers 6 and 7 of the end effector have multiple sets of rollers. In some embodiments, both fingers 6 and 7 also comprise a belt actuated by rollers to move a dish. In other embodiments, at least one finger comprises a belt actuated by rollers to move a dish. In some embodiments, not all fingers comprise a belt actuated by rollers to move a dish. In some embodiments, belts attached to fingers 6 and 7 move in the same direction. In other embodiments, belts attached to fingers 6 and 7 move in different directions. In other embodiments, belts attached to fingers 6 and 7 move in orthogonal directions. In other embodiments, a belt attached to a finger moves to reposition the dish to a different position between fingers 6 and 7.

In some embodiments, rollers 12, 13 with motors are placed proximally. In other embodiments, rollers 12, 13 without the motors are placed distally. In some embodiments, a roller without motors uses bearings to reduce the friction and enable them to roll freely around a roller rod 16. In some embodiments, rollers are mounted on both fingers 6 and 7. The fingers 6 and 7 are attached to the gripper base 1.

In some embodiments, rollers 12 and 13 are connected by a belt 14. The belt is driven by roller 12, which is actuated by a shaft 15 attached to a motor. Since the belt connects to a passive roller 13, any motion of the belt also moves roller 13.

In some embodiments, the belt 14 connecting the two rollers 12, 13 can be made of materials such as silicone, rubber, PVC, and polyurethane. In some embodiments, belt 14 is made of one or more elastic materials. In other embodiments, belt 14 is made of one of more non-elastic materials. In some embodiments, the belt exhibits high friction when in contact with dishes.

In some embodiments, fingers 6 and 7 of the end effector are separated from each other by a distance that is greater than the thickness of a dish.

In some embodiments, belt 14 in fingers 6 and 7 of the end effector has at least one sensor to measure the quality of grasp. In other embodiments, the sensors can measure the pressure exerted by the dish onto the belt of the fingers of the end effector. In some embodiments, a finger comprises at least one roller to sense grasp quality. In some embodiments, the end effector comprises a plurality of sensors to sense pressure exerted on a plurality of regions of a dish. In some embodiments, the pressure data from a sensor is used to grasp a dish securely while not damaging it. In some embodiments, pressure data from a sensor is used to determine if fingers 6 and 7 are in contact with a dish. In some embodiments, pressure data from a sensor is used to determine if fingers 6 and 7 are in contact with each other.

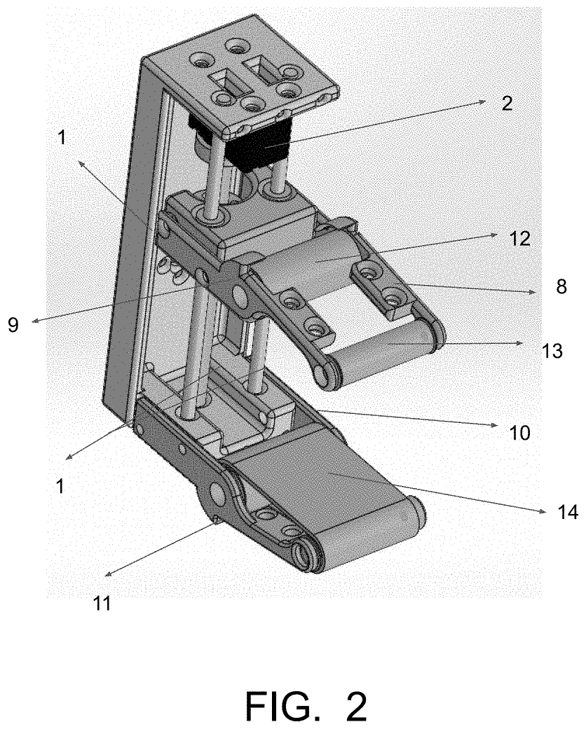

FIG. 2 shows a three-dimensional view of a rolling grasp end effector with fingers 6 and 7 open, showing different parts of the end effector, in accordance with the invention. The main motor 2, attached to a coupler 3, actuates the movement of the finger 6 which can translate up and down. In some embodiments, lead screw 5 converts the rotary motion of motor 2 to translate finger 6. In some embodiments, a processor executes an algorithm to control shaft 15 (and roller 12) to move a dish by moving the belt between rollers. In some embodiments, the processor also executes an algorithm to control motor 2 to hold a dish between fingers 6 and 7. In some embodiments, the dish is grasped by moving it to a position between fingers 6 and 7.

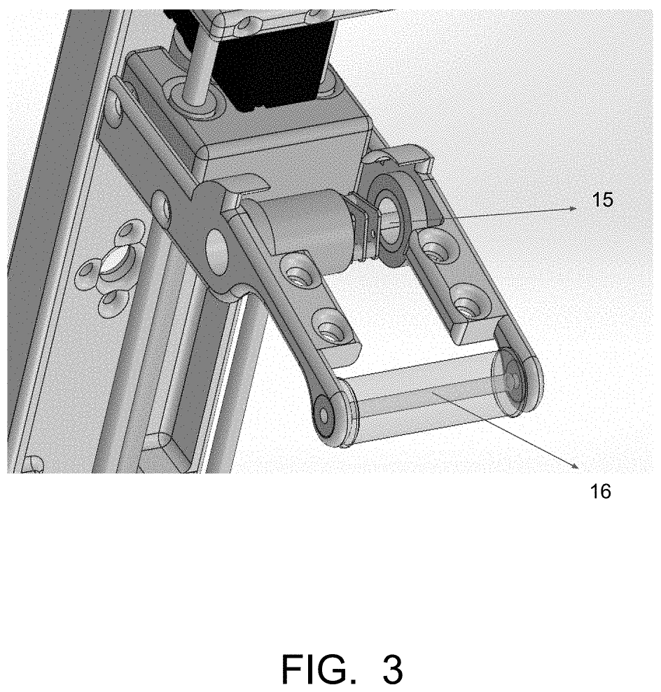

FIG. 3 shows a three-dimensional view of a rolling grasp end effector with fingers 6 and 7 open, showing different parts of fingers 6 and 7, in accordance with the invention. In some embodiments, the distance between fingers 6 and 7 is configured in accordance with the thickness of a dish.

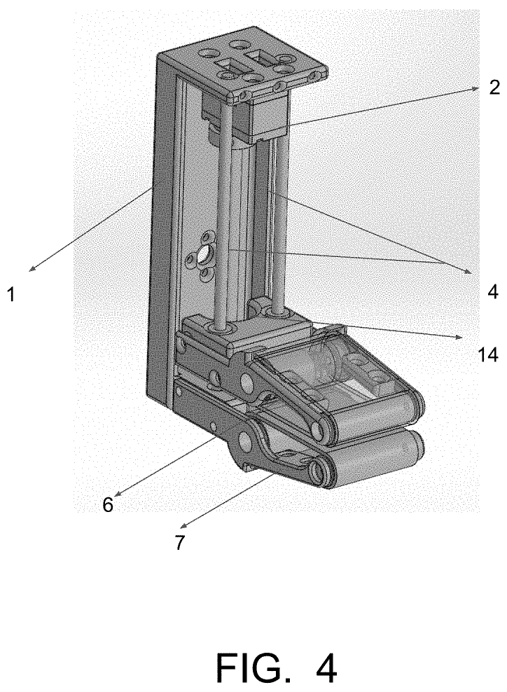

FIG. 4 shows a three-dimensional view of a rolling grasp end effector with fingers 6 and 7 closed to display its minimum stroke length, in accordance with the invention.

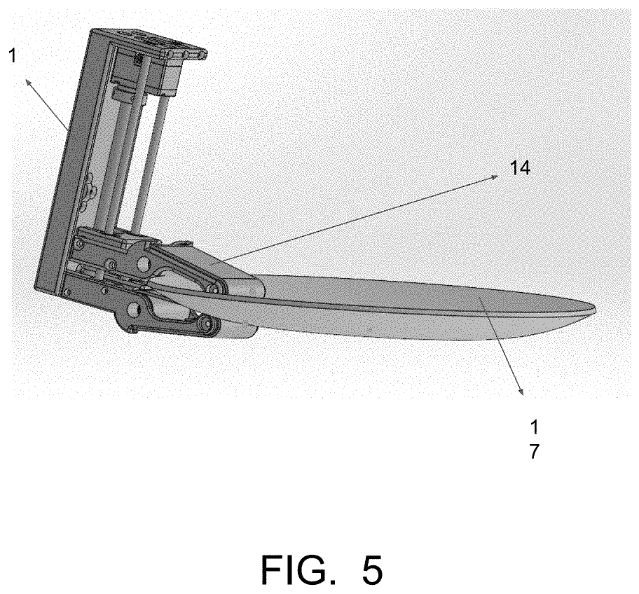

FIG. 5 shows a three-dimensional view of a rolling grasp end effector grasping a plate 17, in accordance with the invention.

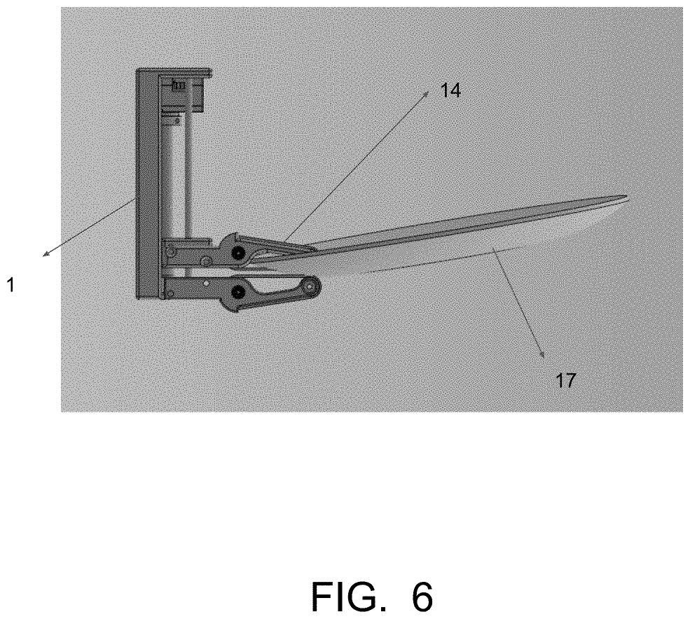

FIG. 6 shows a right-side view of a rolling grasp end effector grasping a plate 17, in accordance with the invention.

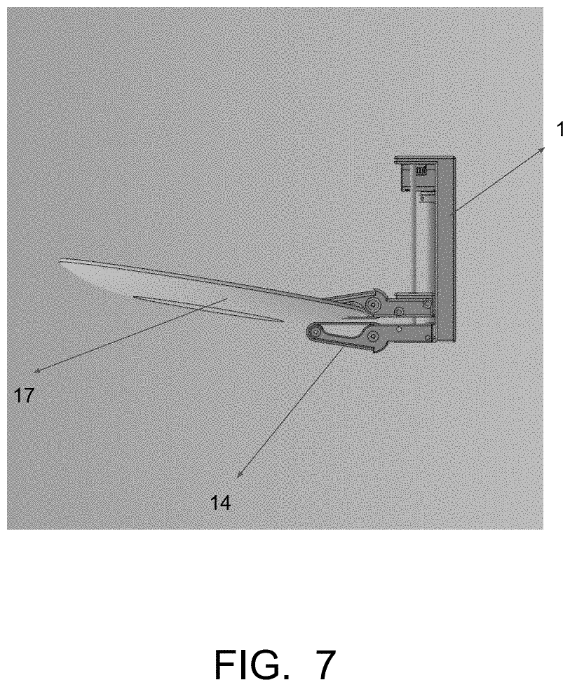

FIG. 7 shows a left-side view of a rolling grasp end effector grasping a plate 17, in accordance with the invention.

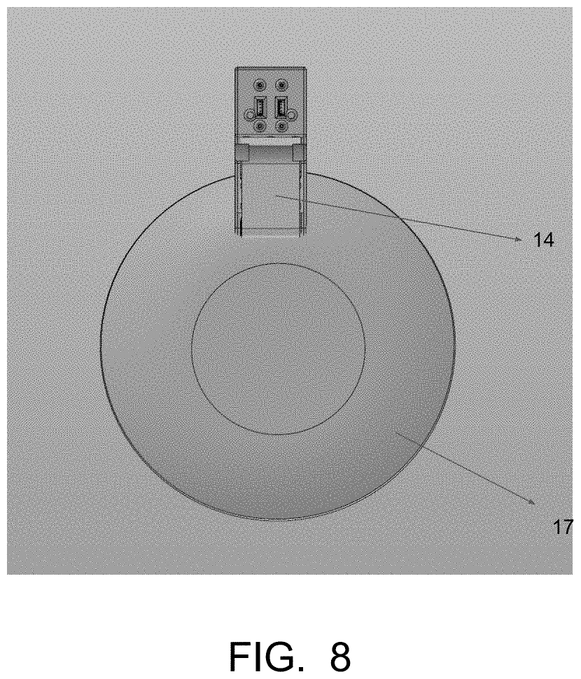

FIG. 8 shows a top view of a rolling grasp end effector grasping a plate 17, in accordance with the invention.

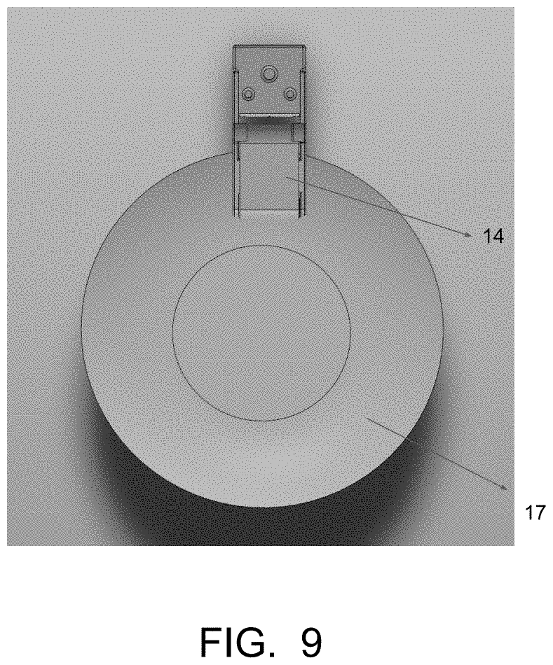

FIG. 9 shows a bottom view of a rolling grasp end effector grasping a plate 17, in accordance with the invention.

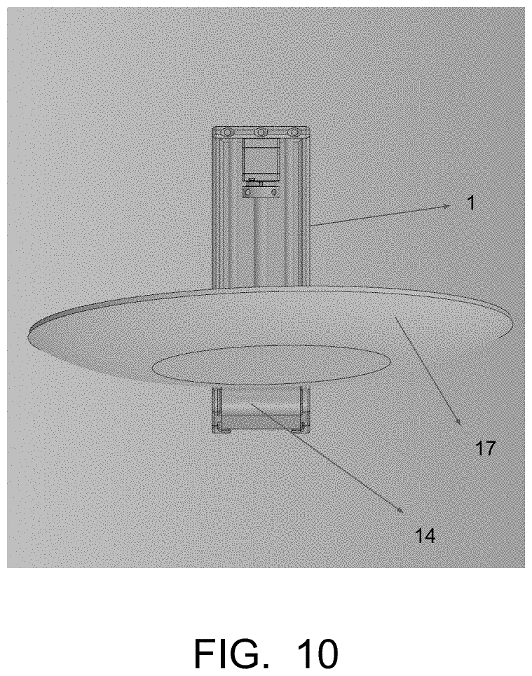

FIG. 10 shows a front view of a rolling grasp end effector grasping a plate 17, in accordance with the invention.

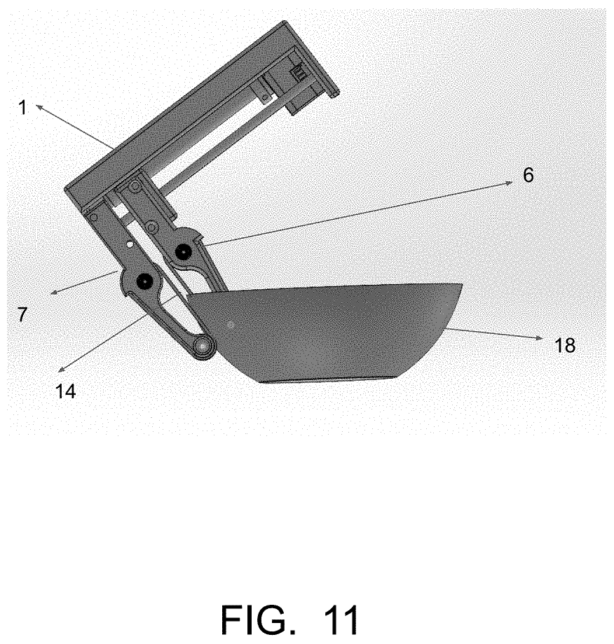

FIG. 11 shows a three-dimensional view of a rolling grasp end effector grasping a bowl 18, in accordance with the invention.

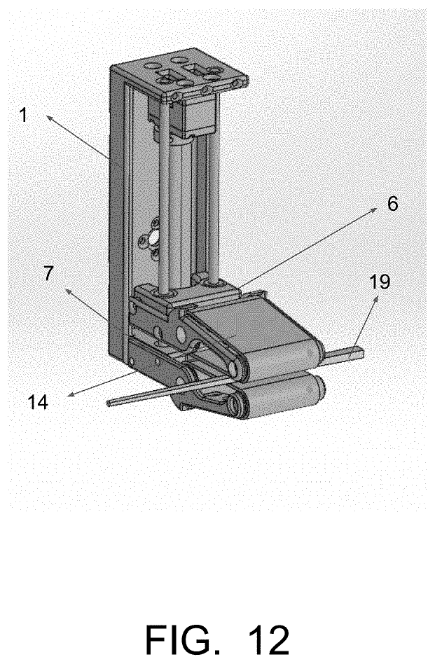

FIG. 12 shows a three-dimensional view of a rolling grasp end effector grasping a pair of chopsticks 19, in accordance with the invention.

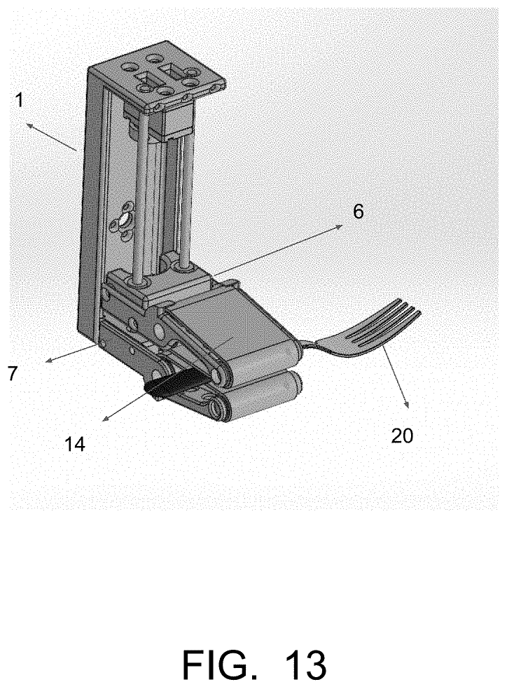

FIG. 13 shows a three-dimensional view of a rolling grasp end effector grasping a fork 20, in accordance with the invention.

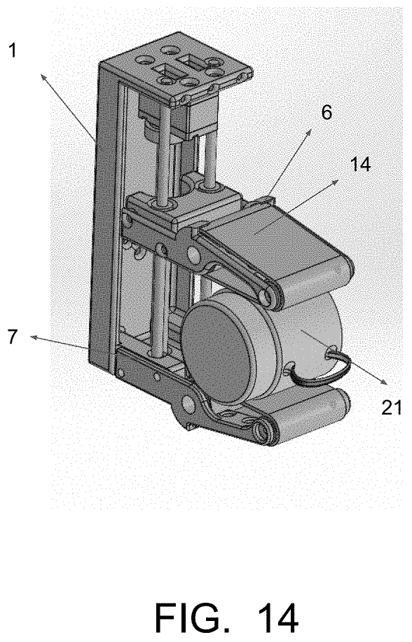

FIG. 14 shows a three-dimensional view of a rolling grasp end effector grasping a mug 21, in accordance with the invention.

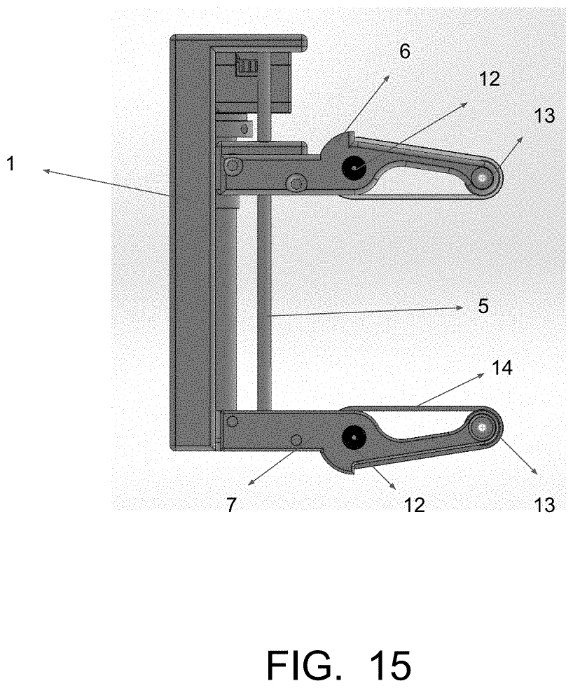

FIG. 15 shows a right-side view of a rolling grasp end effector, in accordance with the invention.

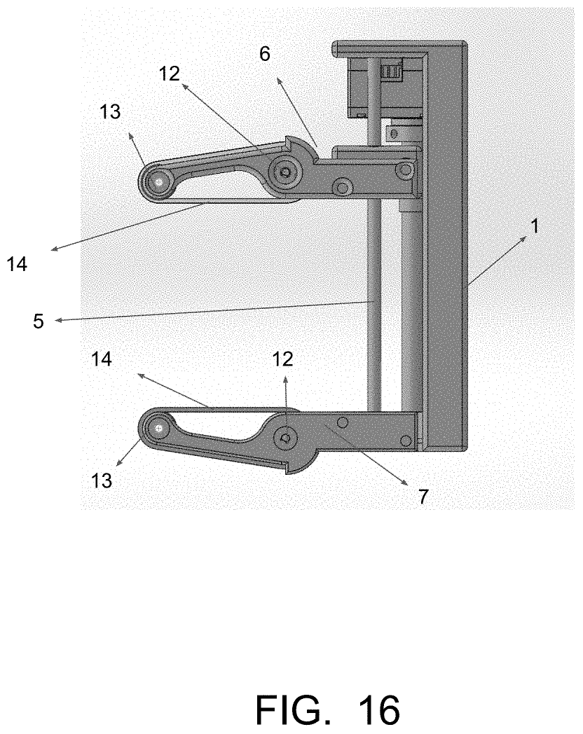

FIG. 16 shows a left-side view of a rolling grasp end effector, in accordance with the invention.

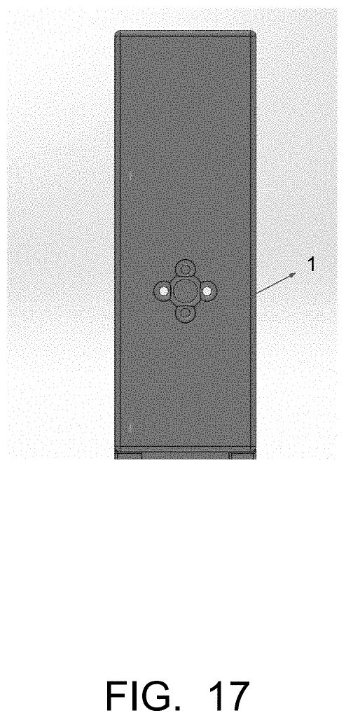

FIG. 17 shows a back view of a rolling grasp end effector, in accordance with the invention.

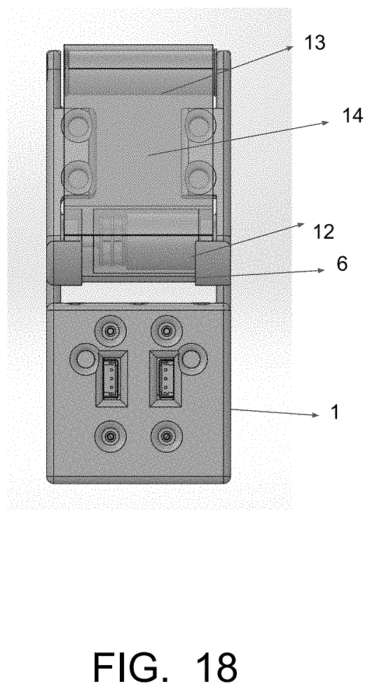

FIG. 18 shows a top view of a rolling grasp end effector, in accordance with the invention.

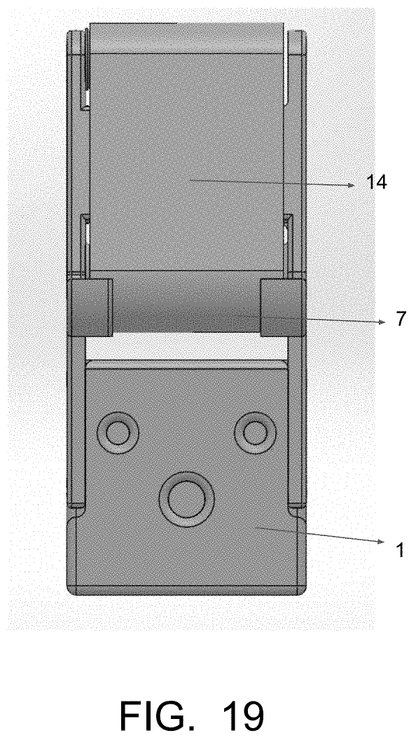

FIG. 19 shows a bottom view of a rolling grasp end effector, in accordance with the invention.

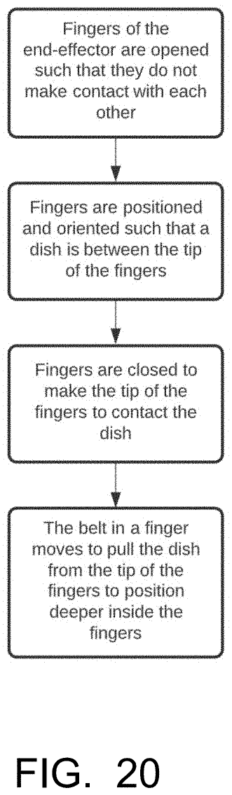

FIG. 20 shows a method for grasping a dish with a rolling grasp end effector, in accordance with the invention. In some embodiments

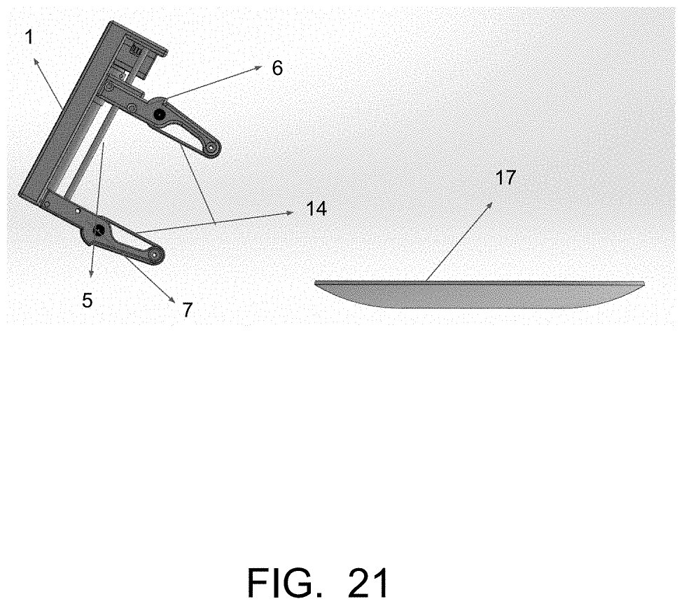

FIG. 21 shows fingers 6 and 7 of the end effector opened such that they do not make contact with each other, in accordance with the invention. In some embodiments, the end effector can open up to a maximum length to accommodate different types of dishes. In other embodiments, the distance between the fingers 6 and 7 of the end effector is greater than the thickness of the dish.

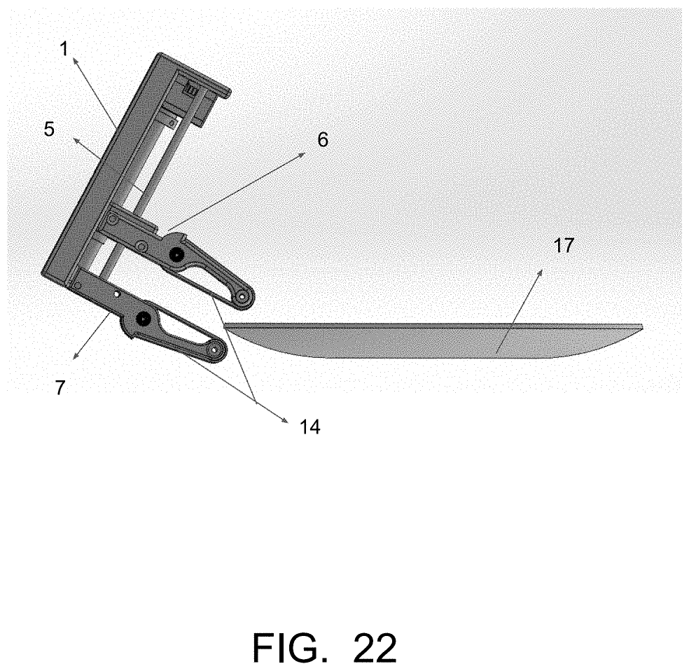

FIG. 22 shows fingers 6 and 7 positioned and oriented such that a dish is between the tip of the fingers 6 and 7, in accordance with the invention. In some embodiments, one of the fingers 6 of the end effector moves towards the dish and positions it such that the dish is in between the two fingers 6 and 7.

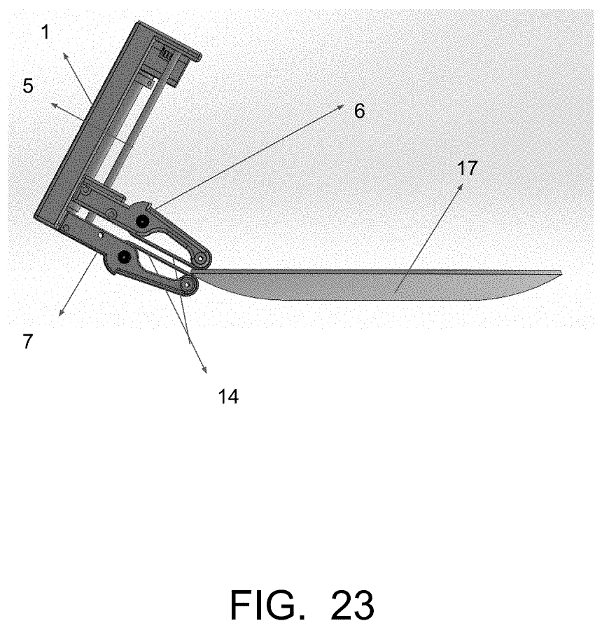

FIG. 23 shows the fingers 6 and 7 closed to make the tip of the fingers to contact the dish, in accordance with the invention.

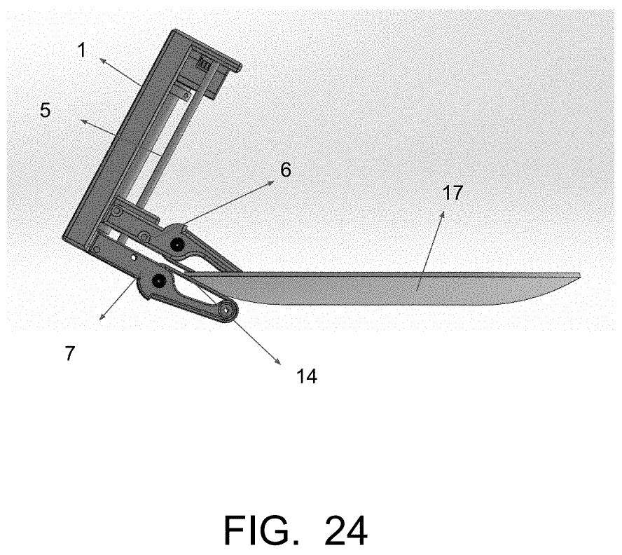

FIG. 24 shows the belt in fingers 6 and 7 moving to pull the dish from the tip of the fingers 6 and 7 to a position deeper inside the fingers, in accordance with the invention. In some embodiments, the fingers 6 and 7 have two sets of rollers 12, 13 attached to them. One roller 12 has a motor embedded in it which helps the roller 12 to roll. The other roller 13 is attached to the roller 12 by a belt 14 which moves along with the rolling motion of the roller 12. In some embodiments, the belt 14 is made of material which can provide high friction when in contact with a dish. The belt is in tension because of which a normal force is exerted between the roller 12 and the belt 14, hence aiding belt 14 to roll along with roller 12 and simultaneously moving roller 13. In other embodiments, because of this movement of the rollers 12, 13 and the belt 14, the dish grasped at the tip of the fingers is pulled towards the deeper end of the fingers 6 and 7. In some embodiments, a dish does not slip when in contact with the belt due to friction between the surfaces of the dish and the belt. In some embodiments, roller 12 does not slip when in contact with belt 14 due to friction between the surfaces of roller 12 and belt 14.

In some embodiments, position and orientation of a dish is perceived to facilitate positioning and orienting finger 6 and finger 7 such that a dish is in between the tip of the fingers.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described above, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as a random access memory (RAM), a read only memory (ROM), a storage device such as a solid state drive (SSD) or a hard drive. Any such computer readable medium may reside on or within a single computational apparatus, and may be present on or within different computational apparatuses within a system or network.

In the claims, reference to an element in the singular is not intended to mean “one and only one” unless explicitly stated, but rather is meant to mean “one or more.” In addition, it is not necessary for a device or method to address every problem that is solvable by different embodiments of the invention in order to be encompassed by the claims.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure. Further, modifications, additions, or omissions may be made to any embodiment without departing from the scope of the disclosure. The components of any embodiment may be integrated or separated according to particular needs without departing from the scope of the disclosure.

One or more features from any embodiment may be combined with one or more features of any other embodiment without departing from the scope of the disclosure. Further, modifications, additions, or omissions may be made to any embodiment without departing from the scope of the disclosure. The components of any embodiment may be integrated or separated according to particular needs without departing from the scope of the disclosure.

What is claimed is:

1. A system for handling an article, comprising:
a) a first finger having a belt to make contact with said article;
b) a first actuator configured to move said belt;
c) a second finger surrounding said article;
d) a second actuator to vary the distance between said first finger and said second finger; and
e) a processor executing an algorithm to control said first actuator to move said article, and to control said second actuator to hold said article,
whereby said article is grasped by moving it to a position between said first finger and said second finger.

2. The system of claim 1, wherein the second finger also comprises a belt and an actuator to move said article.

3. The system of claim 1, wherein said first finger and said second finger are substantially parallel to each other.

4. The system of claim 1, wherein the distance between said first finger and said second finger is greater than the thickness of said article.

5. The system of claim 1, wherein one of the two fingers is stationary and the other finger is moved by said second actuator.

6. The system of claim 1, wherein said first finger or said second finger comprises at least one sensor to sense grasp quality.

7. The system of claim 6, wherein said sensor senses pressure exerted by said article on said belt.

8. The system of claim 1, wherein said first finger or said second finger comprises at least one roller to sense grasp quality.

9. The system of claim 1, wherein said first actuator is a motor connected to a drive roller configured to move said belt.

10. The system of claim 9, further comprising a passive roller that rolls along with said drive roller.

11. The system of claim 1, wherein said belt moves to reposition said article between said first finger and said second finger.

12. The system of claim 1, wherein said article does not slip when in contact with said belt due to friction between the surfaces of said article and said belt.

13. The system of claim 9, wherein said drive roller does not slip when in contact with said belt due to friction between the surfaces of said drive roller and said belt.

14. A method for handling an article, comprising:
a. opening a first finger and a second finger such that they are not in contact with each other, wherein said first finger comprises a belt configured to move said article;
b. positioning and orienting said first finger and said second finger such that said article is in between the tip of said fingers;
c. closing said first finger and said second finger such that the tip of said fingers are in contact with said article; and
d. moving said belt to pull said article from the tip of said fingers to a position deeper inside said fingers,
whereby said article is grasped by moving it to a position between said first finger and said second finger.

15. The method of claim 14, further comprising perceiving position and orientation of said article to facilitate positioning and orienting said first finger and said second finger such that said article is in between the tip of said fingers.

16. The method of claim 14, further comprising a sensor to sense pressure exerted on said article.

17. The method of claim 16, further comprising a plurality of sensors to sense pressure exerted on a plurality of regions of said article.

18. The method of claim 16, wherein pressure data from said sensor is used to grasp said article securely while not damaging it.

19. The method of claim 16, wherein pressure data from said sensor is used to determine if said fingers are in contact with said article.

20. The method of claim 14, wherein said belt is made of an elastic material.
